(19) United States
(12) Patent Application Publication
(10) Pub. No.: US 2025/0293613 A1
(43) Pub. Date: Sep. 18, 2025

(54) SWITCHED-MODE AC-DC POWER CONVERTER

(71) Applicant: Raytheon Systems Limited, Harlow (GB)

(72) Inventors: Raymond F. Blane, Glenrothes (GB); Stewart A. Ritchie, Bridge of Earn (GB)

(21) Appl. No.: 19/079,885

(22) Filed: Mar. 14, 2025

(30) Foreign Application Priority Data
Mar. 15, 2024 (GB) 2403784

(51) Int. Cl. H02M 7/219

(52) U.S. Cl. CPC H02M 7/219

(57) ABSTRACT

A switched-mode AC-DC converter includes (i) first and second pairs of switches connected in a full bridge configuration between AC terminals and DC terminals and (ii) a controller configured to control the switches according to a first switching scheme in which the controller alternates between: a first period in which the first pair of switches is in a first fixed state and the second pair of switches is switched on and off at a higher frequency f_{HIGH}; and a second period in which the first pair of switches is switched on and off at the higher frequency and the second pair of switches is in a second fixed state, where the controller alternates between the first and second period at a line frequency f_{AC} of an AC signal at the AC terminals.

### CROSS-REFERENCE TO RELATED APPLICATION AND PRIORITY CLAIM

This application claims priority under 35 U.S.C. § 119 to United Kingdom Patent Application No. 2403784.8 filed on Mar. 15, 2024, which is hereby incorporated by reference in its entirety.

### TECHNICAL FIELD

The following specification relates to AC-DC power converters.

### BACKGROUND

In power supply systems, such as AC/DC conversion systems, it is known to include power-factor corrector “PFC” circuitry to improve the efficiency of converting AC to DC. Such circuitry may comprise a diode rectifier bridge.

A particular example of PFC circuitry is the so-called Bridgeless Totem-Pole PFC, or BTP-PFC. In the BTP-PFC topology, one half of a diode rectifier bridge is replaced by active switches in a half bridge arrangement. A pair of diodes and the pair of active switches then form a full bridge. The diodes operate at the AC line frequency and the active switches are switched at a higher frequency, usually at least ten times the AC line frequency, which may be referred to as higher frequency switching. The diodes may also be replaced by switches in order to improve efficiency, such as MOSFETs, but due to the different frequencies it is usual for the diodes and the active switches to be formed from different components which can then be optimised for the frequency or any other differences in operating conditions between the diodes and the switches.

Current spikes can occur in AC/DC converters with BTP-PFC configurations. Some known solutions based on a “soft-start mechanism” are discussed in BOSHENG SUN: “How to reduce current spikes at AC zero-crossing for totem-pole PFC”, Texas Instruments, Analog Applications Journal, 4Q 2015, https://www.ti.com/lit/an/slyt650/slyt650.pdf

### SUMMARY

According to a first aspect, the following disclosure provides a switched-mode AC-DC converter comprising: first and second pairs of switches connected in a full bridge configuration between AC terminals and DC terminals, and a controller configured to control the switches according to a first switching scheme in which the controller alternates between: a first period, in which the first pair of switches is in a first fixed state and the second pair of switches is switched on and off at a higher frequency f_{HIGH}; and a second period, in which the first pair of switches is switched on and off at the higher frequency and the second pair of switches is in a second fixed state, wherein the controller alternates between the first and second period at a line frequency f_{AC} of an AC signal at the AC terminals.

According to the first switching scheme, a current spike associated with zero-voltage transitions in the AC signal may be reduced.

The first pair of switches comprises a first switch connected between a first AC terminal and a first DC terminal and a second switch connected between the first AC terminal and a second DC terminal. The second pair of switches comprises a third switch connected between a second AC terminal and the first DC terminal and a fourth switch connected between the second AC terminal and the second DC terminal.

In the first switching scheme, the first and second switches have complementary states and the third and fourth switches have complementary states.

The first and second periods each have a time length equal to half of a period of the AC signal.

Optionally, the switched-mode AC-DC converter additionally comprises an inductor at the first AC terminal and/or at the second AC terminal.

Optionally, the switched-mode AC-DC converter additionally comprises a capacitor connected between the DC terminals.

Optionally, the higher frequency is at least 10 times, at least 100 times or at least 1000 times the frequency of the AC signal.

Optionally, the controller is further configured to control the switches according to a second switching scheme in which the controller alternates between: a third period, in which the first pair of switches is in a third fixed state and the second pair of switches is switched on and off at the higher frequency f_{HIGH}; and a fourth period, in which the first pair of switches is switched on and off at the higher frequency and the second pair of switches is in a fourth fixed state, wherein the controller alternates between the third and fourth period at the line frequency f_{AC} of the AC signal at the AC terminals, and wherein the third fixed state is opposite to the first fixed state, and the fourth fixed state is opposite to the second fixed state. The advantages of the second switching scheme are similar to the advantages of the first switching scheme, but in an alternative implementation.

Optionally, the controller is configured to periodically alternate between the first and second switching schemes. Alternating between the first and second switching schemes can more evenly distribute heat loss and/or wear in the switched-mode AC-DC converter.

According to a second aspect, the following disclosure provides a controller for a switched-mode AC-DC converter comprising first and second pairs of switches connected in a full bridge configuration between AC terminals and DC terminals, the controller configured to control the switches according to a first switching scheme in which the controller alternates between: a first period, in which the first pair of switches is in a first fixed state and the second pair of switches is switched on and off at a higher frequency f_{HIGH}, and a second period, in which the first pair of switches is switched on and off at the higher frequency and the second pair of switches is in a second fixed state, wherein the controller is configured to alternate between the first and second period at a line frequency f_{AC} of an AC signal at the AC terminals. In other words, the controller of the second aspect may be used to control a switched-mode AC-DC converter, in the same way that the switched-mode AC-DC converter is operated in the first aspect. According to the first switching scheme, a current spike associated with zero-voltage transitions in the AC signal may be reduced.

For the second aspect, optionally, the controller is further configured to control the switches according to a second switching scheme in which the controller alternates between: a third period, in which the first pair of switches is in a third fixed state and the second pair of switches is switched on and off at the higher frequency f_{HIGH}; and a fourth period, in which the first pair of switches is switched on and off at the higher frequency and the second pair of switches is in a fourth fixed state, wherein the controller is configured to alternate between the third and fourth period at the line frequency f_{AC} of an AC signal at the AC terminals, and wherein the third fixed state is opposite to the first fixed state, and the fourth fixed state is opposite to the second fixed state. The advantages of the second switching scheme are similar to the advantages of the first switching scheme, but in an alternative implementation.

For the second aspect, optionally, the controller is configured to periodically alternate between the first and second switching schemes. Alternating between the first and second switching schemes can more evenly distribute heat loss and/or wear in the switched-mode AC-DC converter.

According to a third aspect, the following disclosure provides a method for controlling a switched-mode AC-DC converter comprising first and second pairs of switches connected in a full bridge configuration between AC terminals and DC terminals, the method comprising controlling the switches according to a first switching scheme by alternating between: a first period, in which the first pair of switches is in a first fixed state and the second pair of switches is switched on and off at a higher frequency f_{HIGH}, and a second period, in which the first pair of switches is switched on and off at the higher frequency and the second pair of switches is in a second fixed state, the first switching scheme comprising alternating between the first and second period at a line frequency f_{AC} of an AC signal at the AC terminals. In other words, the method of the third aspect may be used to control a switched-mode AC-DC converter, in the same way that the switched-mode AC-DC converter is operated in the first aspect. According to the first switching scheme, a current spike associated with zero-voltage transitions in the AC signal may be reduced.

For the third aspect, optionally, the method further comprises controlling the switches according to a second switching scheme by alternating between: a third period, in which the first pair of switches is in a third fixed state and the second pair of switches is switched on and off at the higher frequency f_{HIGH}; and a fourth period, in which the first pair of switches is switched on and off at the higher frequency and the second pair of switches is in a fourth fixed state, the second switching scheme comprising alternating between the third and fourth period at the line frequency f_{AC} of an AC signal at the AC terminals, and wherein the third fixed state is opposite to the first fixed state, and the fourth fixed state is opposite to the second fixed state. The advantages of the second switching scheme are similar to the advantages of the first switching scheme, but in an alternative implementation.

For the third aspect, optionally, the method comprises periodically alternating between the first and second switching schemes. Alternating between the first and second switching schemes can more evenly distribute heat loss and/or wear in the switched-mode AC-DC converter.

According to a fourth aspect, the following disclosure provides a non-transitory storage medium storing computer program instructions which, when executed by a computer, cause the computer to perform the method of the third aspect.

According to a fifth aspect, the following disclosure provides a computer program comprising instructions which, when executed by a computer, cause the computer to perform the method of the third aspect.

### BRIEF DESCRIPTION OF THE DRAWINGS

The detailed description refers to the following diagrams, as examples:

FIG. 1 schematically illustrates a switched AC/DC converter circuit topology;

FIGS. 2A to 2E illustrate a known switching scheme for the switched AC/DC converter circuit topology;

FIGS. 3A to 3E illustrate a first switching scheme for the switched AC/DC converter circuit topology;

FIGS. 4A to 4E illustrate a second switching scheme for the switched AC/DC converter circuit topology;

FIG. 5 illustrates a combined switching scheme alternating between the first and second switching schemes.

### DETAILED DESCRIPTION

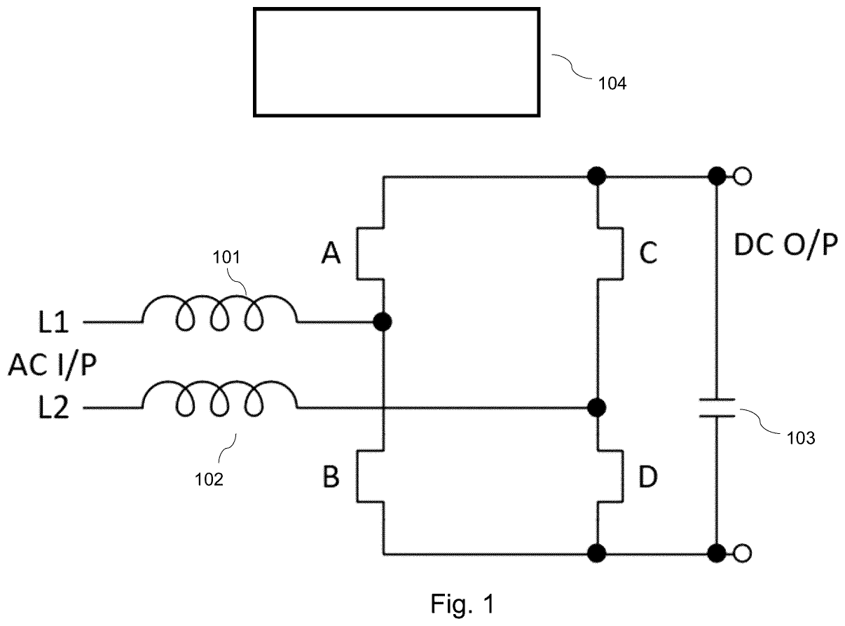

FIG. 1 schematically illustrates the topology of an AC/DC converter circuit which can be operated as a BTP-PFC circuit.

Referring to FIG. 1, the circuit has two AC terminals L1 and L2, and has two DC terminals.

A first pair of switches A and B are connected between a first AC terminal L1 and the DC terminals.

A second pair of switches C and D are connected between a second AC terminal L2 and the DC terminals.

Additionally, the circuit includes an inductor 101, 102 at one or both of the AC terminals L1 and L2. In some embodiments inductor 101 and/or inductor 102 may be implemented using a network of two or more inductor components, such as two or more inductors connected in series. This inductor enables the circuit to provide a boost converter effect in addition to rectification. In some cases, the AC/DC converter may be designed to work with a known AC source having a known effective inductance at the terminals L1 and L2. In such cases, the inductor(s) 101, 102 may be omitted, and the effective inductance of the AC source may be used instead.

Furthermore, the circuit includes a smoothing capacitor 103 connected between the DC terminals. The smoothing capacitor 103 preferably has high capacitance in order to maintain a stable DC voltage. In some cases, the AC/DC converter may be designed to work with a known DC sink having a known effective capacitance between the DC terminals. In such cases, the smoothing capacitor 103 may be omitted, and the effective capacitance of the DC sink may be used instead.

The switches A, B, C and D are controlled by a controller 104. The controller may monitor a state of the AC/DC converter circuit including one or more of: the voltage V_{AC} of an AC signal at the AC terminals, the current IAC of the AC signal at the AC terminals, the voltage V_{DC} of a DC signal at the DC terminals, the current I_{DC} of the DC signal at the DC terminals, and a temperature at one or more locations in the AC/DC converter circuit. Based on the monitored state, the controller may perform one or more of: determining a required level of power factor correction, determining a required duty cycle Δ for switching in order to achieve the power factor correction, and determining a switching scheme for controlling the switches A, B, C, D. In other embodiments, the controller 104 may follow a pre-set switching scheme without responding to a state of the AC/DC converter circuit.

The controller may be implemented using a computer. Herein a computer includes any computing device, chip or logic circuit. The computer may perform a sequential series of operations and/or may perform two or more operations at a time in parallel. The computer may comprise two or more devices connected together, such as a modular local computer or a network of nodes which cooperate to perform the operations of the computer. For example, the computer may comprise one or more of an ASIC, an FPGA, a CPLD, a PLD, or a general-purpose processor. The computer may be a programmable device, or may perform a hard-coded control method, or may combine hard-coded operations with programmable operations. For example, the computer may further comprise a memory storing instructions to be executed. The instructions may, for example, be executed by a processor. The instructions may define one or more of the switching schemes described below, for controlling the switches A, B, C and D. The instructions may be portable. For example, the instructions may be stored in a non-transitory memory (e.g. a flash drive) or in a data signal (e.g. internet communication signal) and may be installed and/or updated in a memory of the controller.

The first and second pairs of switches A, B, C, D together form a full bridge configuration, and can provide full-wave rectification when operated appropriately in an AC-to-DC mode wherein the AC terminals act as inputs and the DC terminals act as outputs. The first and second pairs of switches can equally provide inversion when operated appropriately in a DC-to-AC mode wherein the DC terminals act as inputs and the AC terminals act as outputs.

In conventional AC/DC converter bridge circuits, the switches A, B, C and D are switched at the AC line frequency (which is usually less than 1 kHz). Such low frequency switching can be implemented using diodes or MOSFETS.

However, in a BTP-PFC configuration performing AC-to-DC conversion, the pairs of switches act as a boost converter in addition to acting as a rectifier. One of the pairs of switches acts as a “totem pole” pair of switches, in which one of the switches is controlled as a “boost diode” (labelled BD in the figures), and the other of the switches is controlled as a “boost switch” (labelled BSW in the figures). The boost diode and boost switch are switched such that they have approximately complementary CLOSED/OPEN (i.e. ON/OFF) states. However, in order to avoid short-circuiting the smoothing capacitor 103 (and avoid causing a current spike), a small amount of “dead time” is usually included between switching OFF (OPEN) the boost switch and switching ON (CLOSED) the boost diode, and between switching OFF (OPEN) the boost diode and switching ON (CLOSED) the boost switch.

The “totem pole” pair of switches is controlled at a higher frequency (for example, at least 10 times, at least 100 times, or at least 1000 times higher than the AC line frequency), while the other pair of switches is controlled at the AC line frequency, synchronous with the AC signal at the AC terminals. The higher frequency switching does not need to have a frequency that is an exact multiple of the AC line frequency, or be synchronous with the AC signal. This is because, within the timescale of a single time period of the higher frequency, the AC signal is approximately constant, and the boost conversion effectively performs DC-DC conversion that is decoupled from the lower-frequency AC oscillation.

In order to support higher frequency switching without losing efficiency, The “totem pole” pair of switches may be implemented using any suitable type of switch. For example, the “totem pole” pair of switches may be FETs constructed from a wide bandgap semiconductor such as SiC or GaN.

Additionally, while switches A, B, C and D are illustrated as single switches, each of switches A, B, C and D may be implemented as one or more switches arranged and operated in series and/or parallel. Using multiple switches in parallel may increase the power and/or voltage capability of the AC/DC converter.

The higher frequency switching has a time-varying duty cycle Δ for boost conversion, in order to convert the time-varying voltage V_{AC} of the AC signal at the AC terminals to the voltage V_{DC} of the DC signal at the DC terminals. The duty cycle Δ represents the proportion of CLOSED (i.e. ON) time for the boost switch in a time period of the higher frequency. The boosting may, for example, be performed in any of a continuous conduction mode, a boundary conduction mode, or a discontinuous conduction mode. In some embodiments, the values of the inductor(s) 101, 102 may be chosen such that they can store enough energy to enable continuous conduction mode based on an expected load and an expected AC line frequency.

The boost gain differs depending on the conduction mode. In general, the larger the duty cycle Δ, the larger the voltage gain. Therefore, when V_{IN} is much smaller than V_{OUT}, the converter 104 uses a large value of duty cycle Δ. When an equivalent boosting is applied in a BTP-PFC context for performing AC-to-DC conversion, V_{OUT} is V_{DC} and V_{IN} is V_{AC}, and the converter 104 uses large values of duty cycle Δ, approaching 100%, when V_{AC} is close to a zero-voltage crossing point (i.e. when |V_{AC}|<<V_{DC}).

By varying Δ to convert the time-varying voltage V_{AC} of the AC signal at the AC terminals to the voltage V_{DC} of the DC signal at the DC terminals, harmonic content and distortion are reduced in the AC signal. This is known as power factor correction.

In order to provide consistent boosting between the DC voltage and the AC voltage during both the positive half and the negative half of the AC signal cycle, the roles of the “boost diode” and “boost switch” may swap every time V_{AC} crosses a zero-voltage crossing point (i.e. at the beginning/end of every half-cycle of the AC line frequency).

The same circuit configuration may also be used to perform DC-to-AC conversion, with a suitable switching scheme.

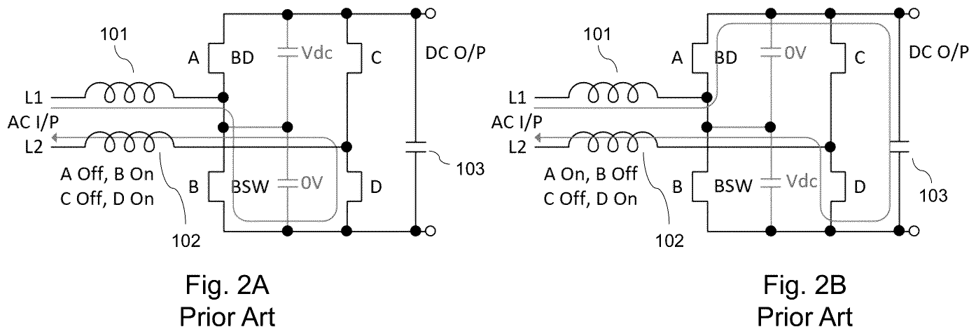

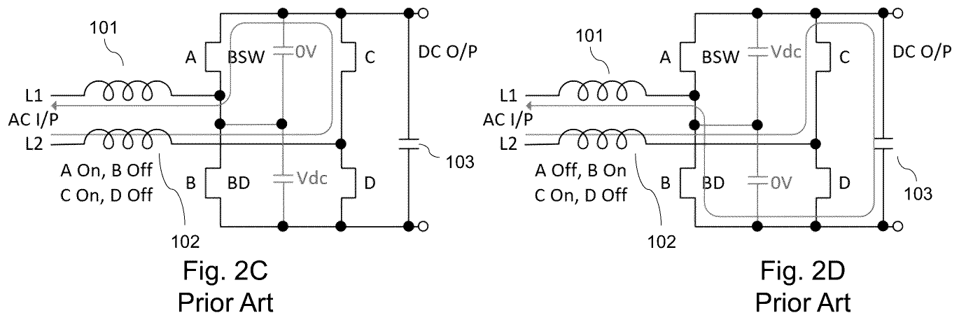

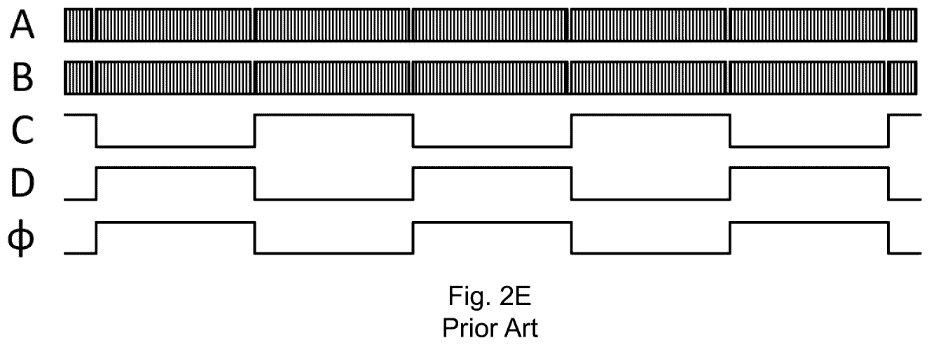

FIGS. 2A to 2E show an example of the above principles, for controlling a BTP-PFC circuit performing AC-to-DC conversion driven by an AC signal having an AC line frequency f_{AC}. In FIGS. 2A to 2E, the switches are controlled according to a known switching scheme.

In FIGS. 2A to 2E, switches A and B are configured as the “totem pole” pair that switches at the higher frequency f_{HIGH}, and switches C and D are configured as the other pair that switches at the AC line frequency.

In FIGS. 2A to 2D, current flow is indicated by a continuous greyscale arrow. Additionally, a parasitic capacitance C_{OSS} of each of the switches A and B is represented as a capacitor in parallel with the switch. A voltage currently applied across each switch A, B is also indicated next to the parasitic capacitance symbol. Although not shown, switches C and D also have a parasitic capacitance. (The value of C_{OSS} may be different for each switch.)

FIGS. 2A and 2B show a first period, in which switches C and D have a fixed configuration, wherein switch C is OPEN (OFF) and switch D is CLOSED (ON). This first period is a period in which the AC signal is positive (e.g. a first half of a sine wave oscillation of the AC signal), and therefore the smoothing capacitor 103 is charged when switches A and D are both CLOSED (ON). On the other hand, when switches B and D are CLOSED (ON), energy is stored in the inductor(s) 101, 102.

During the first period, switch A acts as the boost diode BD and switches at the higher frequency, with a time-varying duty cycle (1-Δ). Switch B acts as the boost switch BSW and switches at the higher frequency, with a time-varying duty cycle Δ. In other words, during the first period, the circuit alternates between the states shown in FIGS. 2A and 2B. The state shown in FIG. 2A lasts for a time period Δ/f_{HIGH}, in which the boost switch B is CLOSED (ON) and boost diode A is OPEN (OFF). The state shown in FIG. 2B lasts for a time period (1-Δ)/f_{HIGH} in which boost switch B is OPEN (OFF) and boost diode A is CLOSED (ON).

FIGS. 2C and 2D show a second period, in which switches C and D have a fixed configuration, wherein switch C is CLOSED (ON) and switch D is OPEN (OFF). This second period is a period in which the AC signal is negative (e.g. a second half of a sine wave oscillation of the AC signal), and therefore the smoothing capacitor 103 is charged when switches B and C are both CLOSED (ON).

During the second period, switch B acts as the boost diode BD and switches at the higher frequency, with a time-varying duty cycle (1-Δ). Switch A acts as the boost switch BSW and switches at the higher frequency, with a time-varying duty cycle Δ. In other words, during the second period, the circuit alternates between the states shown in FIGS. 2C and 2D. The state shown in FIG. 2C lasts for a time period Δ/f_{HIGH}, in which the boost switch A is CLOSED (ON) and boost diode B is OPEN (OFF). The state shown in FIG. 2D lasts for a time period (1-Δ)/f_{HIGH} in which boost switch A is OPEN (OFF) and boost diode B is CLOSED (ON).

FIG. 2E is a timing diagram showing the states of switches A to D through several cycles of the known switching scheme. In the timing diagram, the “high” binary state indicates that a switch is CLOSED (ON), and the “low” binary state indicates that a switch is OPEN (OFF). Time moves forward from left to right of the timing diagram. Additionally, the state φ indicates whether the controller is in a “first period” (the “high” binary state) or a “second period” (the “low” binary state), as described above.

Starting on the left of FIG. 2E, the converter circuit is initially in a “second period” comprising the states shown in FIGS. 2C and 2D, wherein switch C is CLOSED (ON) and switch D is OPEN (OFF), and switches A and B are oscillating at the higher frequency (with switch A being the boost switch having time-varying duty cycle Δ). The converter circuit then switches to a “first period” comprising the states shown in FIGS. 2A and 2B, wherein switch C is OPEN (OFF) and switch D is CLOSED (ON), and the switches A and B continue to oscillate at the higher frequency (with switch B now being the boost switch having time-varying duty cycle Δ). The circuit continues to switch between the “first period” state and the “second period” state every half-cycle of the AC signal.

As mentioned above, FIGS. 2A to 2E illustrate a known switching scheme for BTP-PFC. This known switching scheme has a drawback in the form of a current spike that occurs at the start of every half-cycle of the AC signal. (In other words, the current spike occurs every time the control state φ changes from “first period” to “second period” or from “second period” to “first period”.) This current spike has a number of possible sources.

The current spike can be caused by the parasitic capacitances of the “totem pole” switches A and B and by the sudden change in voltage across the switches A and B when the switches C and D change their states.

More specifically, as mentioned above, when |V_{AC}|<<V_{DC}, the time-varying duty cycle Δ approaches 100%, and the time period (1-Δ)/f_{HIGH} in which boost diode A should be CLOSED (ON) becomes smaller than the “dead time”. This has the effect that, close to the beginning/end of a half-cycle of the AC signal, the boost diode A does not turn ON at all and a residual charge Q_{R}=C_{OSS} V_{DC} builds up due to the parasitic capacitance C_{OSS} of the boost diode A.

Then, when the AC signal goes from positive to negative, the control state φ changes from “first period” to “second period” and the roles of the boost diode and boost switch are reversed as shown in FIGS. 2C and 2D. Now, because switch A has gone from being the boost diode to the boost switch, but the duty cycle Δ remains large, the residual charge rapidly discharges from switch A, causing a short but large current spike.

Other scenarios which may contribute to a current spike are described in BOSHENG SUN: “How to reduce current spikes at AC zero-crossing for totem-pole PFC”, Texas Instruments, Analog Applications Journal, 4Q 2015, https://www.ti.com/lit/an/slyt650/slyt650.pdf.

The current spike introduces noise which can affect the harmonic content of the AC line current, can generate electromagnetic interference around the circuit (affecting compliance with EMI limits), and can have a deleterious effect on the power factor of the circuit, reducing efficiency. Additionally, some of the energy of this current spike is wasted as resistive heat in and around the associated switch (in this case switch A).

In known configurations, current spikes have been addressed by using a “soft-start” at the start of every AC half-cycle, in which the duty cycle Δ is gradually increased from 0% to the required level for power factor correction. However, alternative solutions are desirable, as the known configurations do cannot entirely eliminate the above-described current spike.

In view of the above, the inventors have proposed alternative solutions, comprising switching schemes in which each pair of switches in the bridge configuration alternates between performing switching at the higher frequency and performing switching at the line frequency.

These solutions can avoid a rapid discharge of a residual charge across a switch, and thereby avoid the associated current spike.

In these alternative solutions, all four of switches A, B, C and D are required to perform switching at the higher frequency. In implementations, any suitable switch type may be used. For example, in some implementations, the switches may be FETs constructed from a wide bandgap semiconductor such as SiC or GaN.

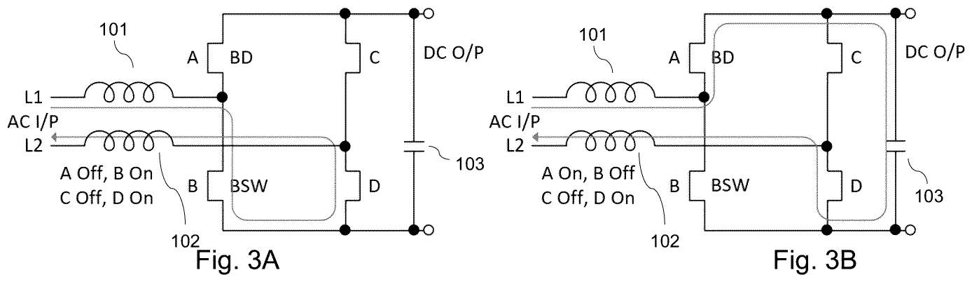

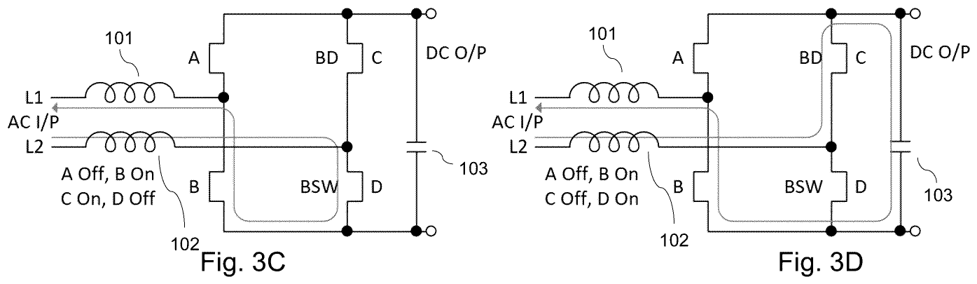

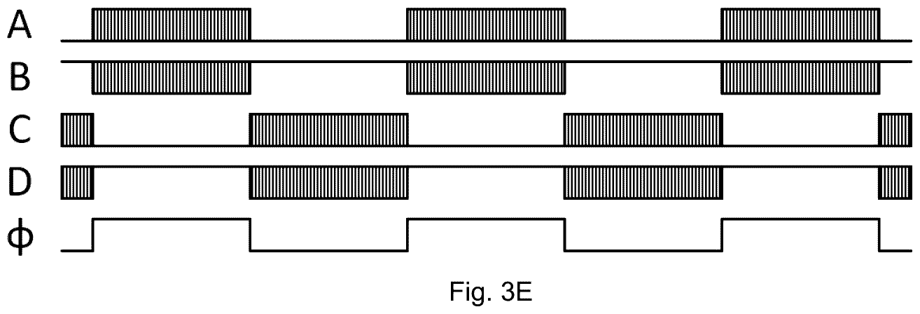

FIGS. 3A to 3E show a first switching scheme, for controlling a BTP-PFC circuit performing AC-to-DC conversion driven by an AC signal having an AC line frequency f_{AC}.

In FIGS. 3A to 3D, current flow is indicated by a continuous greyscale arrow. To avoid confusion regarding which features are “real”, the parasitic capacitances are not shown in these figures (although they will still be present).

FIGS. 3A and 3B show a first period, in which switches A and B are configured as the “totem pole” pair that switches at the higher frequency f_{HIGH}, and switches C and D are configured as the other pair that switches at the AC line frequency. The switches C and D have a fixed configuration, wherein switch Cis OPEN (OFF) and switch D is CLOSED (ON). This first period is a period in which the AC signal is positive (e.g. a first half of a sine wave oscillation of the AC signal), and therefore the smoothing capacitor 103 is charged when switches A and D are both CLOSED (ON). On the other hand, when switches B and D are CLOSED (ON), energy is stored in the inductor(s) 101, 102.

During the first period, switch A acts as the boost diode BD and switches at the higher frequency, with a time-varying duty cycle (1-Δ). Switch B acts as the boost switch BSW and switches at the higher frequency, with a time-varying duty cycle Δ. In other words, during the first period, the circuit alternates between the states shown in FIGS. 3A and 3B. The state shown in FIG. 3A lasts for a time period Δ/f_{HIGH}, in which the boost switch B is CLOSED (ON) and boost diode A is OPEN (OFF). The state shown in FIG. 3B lasts for a time period (1-Δ)/f_{HIGH} in which boost switch B is OPEN (OFF) and boost diode A is CLOSED (ON).

FIGS. 3C and 3D show a second period, in which switches C and D are configured as the “totem pole” pair that switches at the higher frequency f_{HIGH}, and switches A and B are configured as the other pair that switches at the AC line frequency. The switches A and B have a fixed configuration, wherein switch B is CLOSED (ON) and switch A is OPEN (OFF). This second period is a period in which the AC signal is negative (e.g. a second half of a sine wave oscillation of the AC signal), and therefore the smoothing capacitor 103 is charged when switches B and C are both CLOSED (ON).

During the second period, switch C acts as the boost diode BD and switches at the higher frequency, with a time-varying duty cycle (1-Δ). Switch D acts as the boost switch BSW and switches at the higher frequency, with a time-varying duty cycle Δ. In other words, during the second period, the circuit alternates between the states shown in FIGS. 3C and 3D. The state shown in FIG. 3C lasts for a time period Δ/f_{HIGH}, in which the boost switch D is CLOSED (ON) and boost diode C is OPEN (OFF). The state shown in FIG. 3D lasts for a time period (1-Δ)/f_{HIGH} in which boost switch D is OPEN (OFF) and boost diode C is CLOSED (ON).

FIG. 3E is a timing diagram showing the states of switches A to D through several cycles of the first switching scheme. In the timing diagram, the “high” binary state indicates that a switch is CLOSED (ON), and the “low” binary state indicates that a switch is OPEN (OFF). Time moves forward from left to right of the timing diagram. Additionally, the state φ indicates whether the controller is in a “first period” (the “high” binary state) or a “second period” (the “low” binary state), as described above.

Starting on the left of FIG. 3E, the converter circuit is initially in a “second period” comprising the states shown in FIGS. 3C and 3D, wherein switch B is CLOSED (ON) and switch A is OPEN (OFF), and switches C and D are oscillating at the higher frequency (with switch D being the boost switch having time-varying duty cycle 4). The converter circuit then switches to a “first period” comprising the states shown in FIGS. 3A and 3B, wherein switch C is OPEN (OFF) and switch D is CLOSED (ON), and the switches A and B oscillate at the higher frequency (with switch B now being the boost switch having time-varying duty cycle Δ). The circuit continues to switch between the “first period” state and the “second period” state every half-cycle of the AC signal.

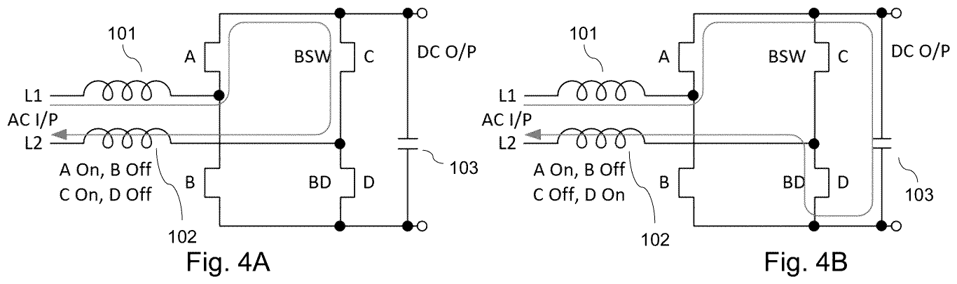

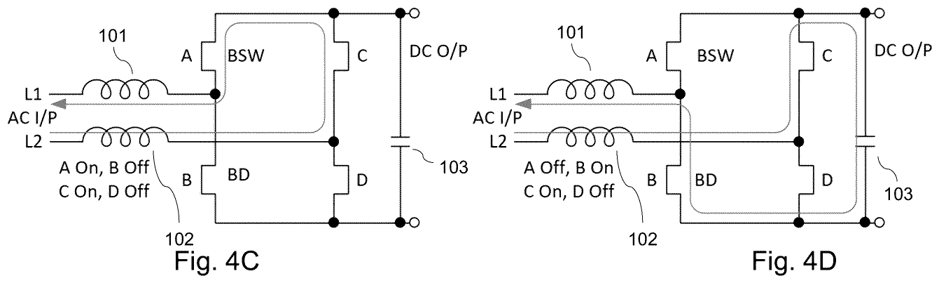

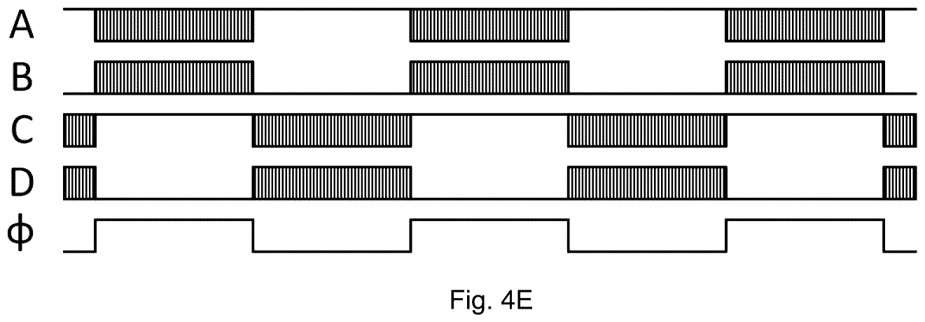

FIGS. 4A to 4E show a second switching scheme, for controlling a BTP-PFC circuit performing AC-to-DC conversion driven by an AC signal having an AC line frequency f_{AC}.

In FIGS. 4A to 4D, current flow is indicated by a continuous greyscale arrow. To avoid confusion regarding which features are “real”, the parasitic capacitances are not shown in these figures (although they will still be present).

FIGS. 4A and 4B show a third period, in which switches C and D are configured as the “totem pole” pair that switches at the higher frequency f_{HIGH}, and switches A and B are configured as the other pair that switches at the AC line frequency. The switches A and B have a fixed configuration, wherein switch B is OPEN (OFF) and switch A is CLOSED (ON). This third period is a period in which the AC signal is positive (e.g. a first half of a sine wave oscillation of the AC signal), and therefore the smoothing capacitor 103 is charged when switches A and D are both CLOSED (ON) as shown in FIG. 4B. On the other hand, when switches A and C are CLOSED (ON) as shown in FIG. 4A, energy is stored in the inductor(s) 101, 102.

During the third period, switch D acts as the boost diode BD and switches at the higher frequency, with a time-varying duty cycle (1-Δ). Switch C acts as the boost switch BSW and switches at the higher frequency, with a time-varying duty cycle Δ. In other words, during the third period, the circuit alternates between the states shown in FIGS. 4A and 4B. The state shown in FIG. 4A lasts for a time period Δ/f_{HIGH}, in which the boost switch Cis CLOSED (ON) and boost diode D is OPEN (OFF). The state shown in FIG. 4B lasts for a time period (1-Δ)/f_{HIGH} in which boost switch C is OPEN (OFF) and boost diode D is CLOSED (ON).

FIGS. 4C and 4D show a fourth period, in which switches A and B are configured as the “totem pole” pair that switches at the higher frequency f_{HIGH}, and switches C and D are configured as the other pair that switches at the AC line frequency. The switches C and D have a fixed configuration, wherein switch C is CLOSED (ON) and switch D is OPEN (OFF). This fourth period is a period in which the AC signal is negative (e.g. a second half of a sine wave oscillation of the AC signal), and therefore the smoothing capacitor 103 is charged when switches B and C are both CLOSED (ON).

During the fourth period, switch B acts as the boost diode BD and switches at the higher frequency, with a time-varying duty cycle (1-Δ). Switch A acts as the boost switch BSW and switches at the higher frequency, with a time-varying duty cycle Δ. In other words, during the fourth period, the circuit alternates between the states shown in FIGS. 4C and 4D. The state shown in FIG. 4C lasts for a time period Δ/f_{HIGH}, in which the boost switch A is CLOSED (ON) and boost diode B is OPEN (OFF). The state shown in FIG. 4D lasts for a time period (1-Δ)/f_{HIGH} in which boost switch A is OPEN (OFF) and boost diode B is CLOSED (ON).

FIG. 4E is a timing diagram showing the states of switches A to D through several cycles of the second switching scheme. In the timing diagram, the “high” binary state indicates that a switch is CLOSED (ON), and the “low” binary state indicates that a switch is OPEN (OFF). Time moves forward from left to right of the timing diagram. Additionally, the state φ indicates whether the controller is in a “fourth period” (the “high” binary state) or a “third period” (the “low” binary state), as described above.

Starting on the left of FIG. 4E, the converter circuit is initially in a “third period” comprising the states shown in FIGS. 4A and 4B, wherein switch A is CLOSED (ON) and switch B is OPEN (OFF), and switches C and D are oscillating at the higher frequency (with switch C being the boost switch having duty cycle Δ). The converter circuit then switches to a “fourth period” comprising the states shown in FIGS. 4C and 4D, wherein switch D is OPEN (OFF) and switch C is CLOSED (ON), and the switches A and B oscillate at the higher frequency (with switch A now being the boost switch having duty cycle Δ). The circuit continues to switch between the “third period” state and the “fourth period” state every half-cycle of the AC signal.

In the first and second switching scheme examples of FIGS. 3A to 4E, at each zero-voltage V_{AC} crossing point at the end of an AC half-cycle, the role of the f_{AC} switch which is OPEN (OFF) for the next half-cycle is taken over by the f_{HIGH} totem pole switch which acted as boost diode in the previous half-cycle. As mentioned above, at the beginning and end of each AC half-cycle, the boost switch has a duty cycle Δ close to 100% and, because of the “dead time” added when switching, the boost diode does not turn on at all (i.e. its duty cycle is 0%). Since the boost diode is never ON (CLOSED) during this period at the beginning/end of an AC half-cycle, a residual charge Q_{R}=C_{OSS} V_{DC} due to parasitic capacitance is stored on the boost diode. When the same switch, that previously acted as the boost diode, is set to be OPEN (OFF) for the next half-cycle, the voltage across that switch remains V_{DC}, and the parasitic capacitance is neither charged nor discharged. Thus, the sudden discharge of the residual charge on the boost diode can be reduced or entirely avoided, reducing or eliminating the corresponding current spike.

As a further solution, the first switching scheme (as shown in FIGS. 3A to 3E) and the second switching scheme (as shown in FIGS. 4A to 4E) may be combined.

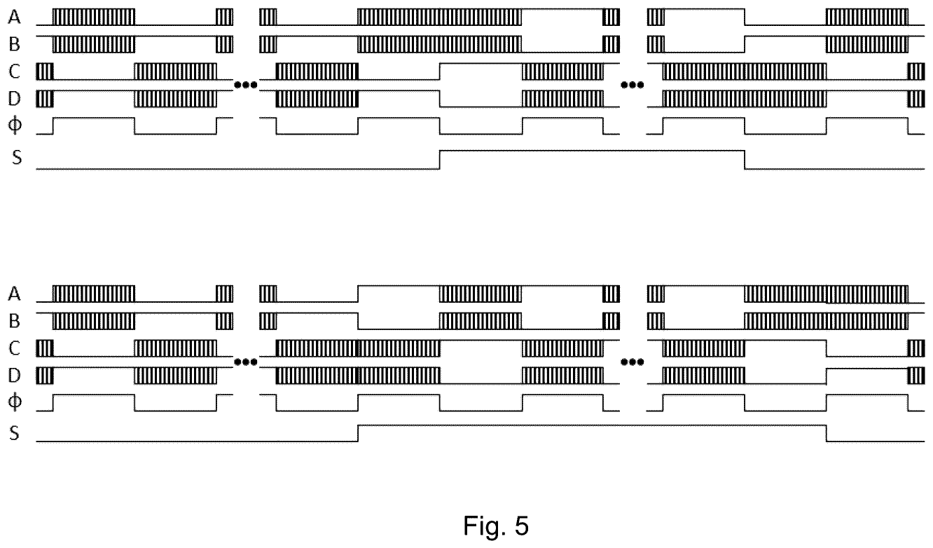

More specifically, the controller 104 may periodically switch between operating the switches according to the first switching scheme and operating the switches according to the second switching scheme. An example of this is illustrated in FIG. 5.

FIG. 5 is a timing diagram showing the states of switches A to D through several cycles of the first and second switching schemes. In the timing diagram, the “high” binary state indicates that a switch is CLOSED (ON), and the “low” binary state indicates that a switch is OPEN (OFF). Time moves forward from left to right of the timing diagram. Additionally, the state φ indicates whether the controller is in a “first/fourth period” (the “high” binary state) or a “second/third period” (the “low” binary state), as described above. Finally, the state S indicates whether the controller is using the first switching scheme (the “low” binary state) or the second switching scheme (the “high” binary state).

Starting on the left of FIG. 5, the converter circuit is initially using the first switching scheme and is in a “second period” (low φ and low S) comprising the states shown in FIGS. 3C and 3D, wherein switch B is CLOSED (ON) and switch A is OPEN (OFF), and switches C and D are oscillating at the higher frequency (with switch D being the boost switch having duty cycle 4).

The converter circuit then switches to a “first period” (high φ and low S) comprising the states shown in FIGS. 3A and 3B, wherein switch C is OPEN (OFF) and switch D is CLOSED (ON), and the switches A and B oscillate at the higher frequency (with switch B now being the boost switch having duty cycle Δ).

For a while, the circuit continues to switch between the “first period” state and the “second period” state every half-cycle of the AC signal.

Then, as marked by the transition in state S, the converter switches to the second switching scheme and to a “third period” (low φ and high S)) comprising the states shown in FIGS. 4A and 4B, wherein switch A is CLOSED (ON) and switch B is OPEN (OFF), and switches C and D are oscillating at the higher frequency (with switch C being the boost switch having duty cycle Δ).

The converter circuit then switches to a “fourth period” comprising the states shown in FIGS. 4C and 4D, wherein switch D is OPEN (OFF) and switch Cis CLOSED (ON), and the switches A and B oscillate at the higher frequency (with switch A now being the boost switch having duty cycle Δ).

For a further while, the circuit continues to switch between the “third period” state and the “fourth period” state every half-cycle of the AC signal. Then, as marked by another transition in state S, the converter switches back to the first switching scheme, and so on.

Combining the first and second switching schemes has the advantage of more evenly distributing the switching roles between the switches A, B, C and D. For example, in the first switching scheme (FIGS. 3A to 3E), the switch A never acts as the boost switch and, in the second switching scheme (FIGS. 4A to 4E), the switch A never acts as the boost diode. By alternating between the first and second switching scheme, all switching roles are performed by all of the switches, and any associated current spikes, noise, current losses or wear on the switches is more evenly distributed. Preferably, when the first and second switching schemes are combined, the controller spends approximately equal amounts of time operating in the first switching scheme and in the second switching scheme, and therefore any associated current spikes, noise, current losses or wear is evenly distributed across all four switch positions.

However, switching between the first and second switching schemes may itself cause a current spike. This scheme switching may be performed less frequently than every AC half-cycle (the frequency of switching between the first and second period or switching between the third and fourth period). For example, scheme switching may be performed less frequently than every 10 AC half-cycles, or less frequently than every 100 AC half-cycles. Nevertheless, it is desirable to reduce any current spikes associated with switching between the first and second switching schemes. These current spikes may be mitigated by using the above-described “soft-start” technique, and/or by ensuring that, immediately prior to the zero voltage crossing in the AC signal, and with sufficient inductor current flowing, the boost switch is turned OFF (OPEN). Current would flow through the boost diode which results in the zero-voltage condition suitable for transitioning from one switching scheme to the other with a reduced or eliminated current spike.

Additionally, any of the above solutions may be combined with the known technique of addressing current spikes by using a “soft-start” at the start of every AC half-cycle. In a soft-start, the duty cycle Δ is gradually increased from 0% to the required level for power factor correction.

What is claimed is:

1. A switched-mode AC-DC converter comprising:
first and second pairs of switches connected in a full bridge configuration between AC terminals and DC terminals; and
a controller configured to control the switches according to a first switching scheme in which the controller alternates between:
a first period in which the first pair of switches is in a first fixed state and the second pair of switches is switched on and off at a higher frequency f_{HIGH}, and
a second period in which the first pair of switches is switched on and off at the higher frequency and the second pair of switches is in a second fixed state;
wherein the controller alternates between the first and second period at a line frequency f_{AC} of an AC signal at the AC terminals.

2. The switched-mode AC-DC converter according to claim 1, wherein the controller is further configured to control the switches according to a second switching scheme in which the controller alternates between:
a third period in which the first pair of switches is in a third fixed state and the second pair of switches is switched on and off at the higher frequency f_{HIGH}, and
a fourth period in which the first pair of switches is switched on and off at the higher frequency and the second pair of switches is in a fourth fixed state;
wherein the controller alternates between the third and fourth period at the line frequency f_{AC} of the AC signal at the AC terminals; and
wherein the third fixed state is opposite to the first fixed state and the fourth fixed state is opposite to the second fixed state.

3. The switched-mode AC-DC converter according to claim 2, wherein the controller is configured to periodically alternate between the first and second switching schemes.

4. A controller for a switched-mode AC-DC converter comprising first and second pairs of switches connected in a full bridge configuration between AC terminals and DC terminals, the controller configured to control the switches according to a first switching scheme in which the controller alternates between:
a first period in which the first pair of switches is in a first fixed state and the second pair of switches is switched on and off at a higher frequency f_{HIGH}; and
a second period in which the first pair of switches is switched on and off at the higher frequency and the second pair of switches is in a second fixed state;
wherein the controller is configured to alternate between the first and second period at a line frequency f_{AC} of an AC signal at the AC terminals.

5. The controller for a switched-mode AC-DC converter according to claim 4, wherein the controller is further configured to control the switches according to a second switching scheme in which the controller alternates between:
a third period in which the first pair of switches is in a third fixed state and the second pair of switches is switched on and off at the higher frequency f_{HIGH}, and
a fourth period in which the first pair of switches is switched on and off at the higher frequency and the second pair of switches is in a fourth fixed state;
wherein the controller is configured to alternate between the third and fourth period at the line frequency f_{AC} of the AC signal at the AC terminals; and
wherein the third fixed state is opposite to the first fixed state and the fourth fixed state is opposite to the second fixed state.

6. The controller for a switched-mode AC-DC converter according to claim 5, wherein the controller is configured to periodically alternate between the first and second switching schemes.

7. A method for controlling a switched-mode AC-DC converter comprising first and second pairs of switches connected in a full bridge configuration between AC terminals and DC terminals, the method comprising:
controlling the switches according to a first switching scheme by alternating between:
a first period in which the first pair of switches is in a first fixed state and the second pair of switches is switched on and off at a higher frequency f_{HIGH}, and
a second period in which the first pair of switches is switched on and off at the higher frequency and the second pair of switches is in a second fixed state;
wherein the first switching scheme comprises alternating between the first and second period at a line frequency f_{AC} of an AC signal at the AC terminals.

8. The method according to claim 7, further comprising:
controlling the switches according to a second switching scheme by alternating between:
a third period in which the first pair of switches is in a third fixed state and the second pair of switches is switched on and off at the higher frequency f_{HIGH}, and
a fourth period in which the first pair of switches is switched on and off at the higher frequency and the second pair of switches is in a fourth fixed state;
wherein the second switching scheme comprises alternating between the third and fourth period at the line frequency f_{AC} of the AC signal at the AC terminals; and
wherein the third fixed state is opposite to the first fixed state and the fourth fixed state is opposite to the second fixed state.

9. The method according to claim 8, wherein the method comprises periodically alternating between the first and second switching schemes.

10. A non-transitory storage medium storing computer program instructions that, when executed by a computer, cause the computer to perform the method of claim 7.
